(19) United States
(12) Patent Application Publication
(10) Pub. No.: US 2016/0068098 A1
(43) Pub. Date: Mar. 10, 2016

(54) MOTOR VEHICLE HEADLIGHT

(71) Applicant: VALEO VISION, Bobigny Cedex (FR)

(72) Inventors: Pierre Albou, Paris (FR); Vincent Godbillon, Paris (FR)

(21) Appl. No.: 14/888,208

(22) PCT Filed: May 28, 2014
(86) PCT No.: PCT/EP2014/061190

§ 371 Date: Oct. 30, 2015

(30) Foreign Application Priority Data
May 30, 2013 (FR) 1354911

(51) Int. Cl. B60Q 1/18; F21S 8/10

(52) U.S. Cl. CPC B60Q 1/18; F21S 48/1747

(57) ABSTRACT

A motor vehicle headlight including a plurality of light modules, wherein it includes a first group of modules to form at least two juxtaposed transverse light strips (H1, H2, H3; H1.1 . . . H3.3), and at least a second group of modules arranged to form contiguous juxtaposed vertical light strips (M1, A1.1 . . . A1.8).

The invention relates to a motor vehicle headlight, including at least one light module having at least one light source and optical means to form a pattern, or pixel.

EP 2 278 217 discloses a light module for a motor vehicle which makes it possible to ensure a “partial high beam mode”. A headlamp of the vehicle is equipped with a plurality of modules which provide a light beam, in particular a high beam, composed of a plurality of adjacent and contiguous vertical strips. By extinguishing one or a plurality of these vertical strips, it is possible to generate, in a high beam, one or a plurality of dark areas corresponding to places where vehicles approaching in the opposite direction or driving in front of the vehicle in question are present, so as to avoid causing glare to other drivers while illuminating the road to either side of the approaching vehicles or the vehicles in front. Such a function is referred to as ADB (Adaptive Driving Beam) or GFHB (Glare Free High Beam).

A headlight equipped with such modules makes it possible to maintain illumination on a large surface of the road, which is beneficial for driving.

The light beam constituted by a plurality of vertical strips is generally referred to as a “matrix beam”. The pattern constituted by a light strip is frequently referred to as a “pixel”.

When meeting a vehicle, in particular substantially at the same height as the vehicle in question, the extinguishing of one or a plurality of vertical strips of the light beam will generally result in a loss of light around the vehicle approaching in the opposite direction, in particular above the vehicle, which is inconvenient for driving, since it generates a loss of visibility on the road beyond the oncoming vehicle.

In the context of an undulating road, the extinguishing of one or a plurality of vertical strips of the beam, so as to avoid causing glare to approaching vehicles or vehicles in front, may result in a loss of near light and in insufficient illumination on the closest part of the road, which is also very inconvenient for driving.

The object of the invention is, in particular, to propose a headlamp for a motor vehicle which makes it possible, in a simple manner, in the majority of cases to maintain illumination above and/or below and/or to the side of an approaching vehicle, or a vehicle in front, regardless of the context of the road where the vehicles are being driven.

The light strips are preferably juxtaposed, with contiguous edges. The optical means are advantageously arranged in order to generate horizontal light strips of which the contour has at least two edges that are opposite and parallel one to the other.

The optical means may be arranged in order to generate horizontal light strips, of which the contour is rectangular or square.

The optical means may be arranged to form at least two transverse light strips extending for the full width of the beam of the headlight.

According to another possibility, the optical means are arranged to form at least two transverse light strips extending only for a fraction of the width of the beam of the headlight. The fraction of the width of the beam may correspond to one third of the width.

The invention thus relates to a motor vehicle headlight including a plurality of light modules, characterized in that it includes a first group of modules arranged to form at least two juxtaposed transverse light strips, and at least a second group of modules to form contiguous juxtaposed vertical light strips.

The transverse strips advantageously extend only for a fraction of the width of the beam of the headlight. For example, they may extend for one third of the width. This advantageous characterizing feature makes it possible to concentrate more light in the central part of the beam and, by so doing, to improve the range. In addition, at an equivalent level of illumination, this makes it possible to reduce the power of the light sources (in particular LEDs) that are used and, as a result, the cost.

The transverse strips are preferably horizontal. According to one variant, they have contiguous edges.

According to one variant, the first group of modules includes a plurality of modules in order to produce at least two segmented transverse strips, each module forming a pattern in the form of a transverse strip corresponding to a fraction of the total width of the beam of the headlight.

According to a development of this variant embodiment, the first group of modules may include a plurality of modules in order to produce at least two segmented transverse strips extending over the full width of the beam, each module forming a pattern in the form of a transverse strip corresponding to a fraction of the total width of the beam of the headlight.

The first group of modules may include modules in order to form three segmented transverse light strips, in particular horizontal, offset vertically and juxtaposed with contiguous edges extending for the entire width of the beam, each strip being composed of three fractions extending for one third of the width of the beam of the headlight.

The second group of modules may include modules in order to form nine contiguous juxtaposed vertical strips, having one central strip and four lateral strips on each side.

According to one variant, the extent of the transverse strips decreases in the vertical sense, from bottom to top, the lower strip being more extensive than the successive upper strip.

According to another variant, the transverse strips are distributed symmetrically in relation to the vertical axis passing through the optical axis of the headlight.

Alternatively, the assembly made up of the transverse strips is offset to one side or the other in relation to the vertical axis passing through the optical axis of the headlight, said strips being at least tangential to said vertical axis along one edge.

Means of control are provided for the different modules in such a way as to form a non-illuminated zone in which a vehicle approaching in the opposite direction or driving in front of the vehicle in question will be present, said non-illuminated zone being present at the intersection of at least two extinguished strips, one vertical, the other horizontal.

The invention also has as its object a lighting assembly for a motor vehicle including a left headlight and a right headlight, mounted respectively on the left side and on the right side at the front of the vehicle, said left and right headlights being consistent with the invention.

According to an advantageous variant, the distribution of the transverse strips of the first group of modules is different between the left headlight and the right headlight.

In particular, the assembly made up of the transverse strips of the left headlight is offset to the left side in relation to the vertical axis passing through the optical axis of the left headlight, and the assembly made up of the transverse strips of the right headlight is offset to the right side in relation to the vertical axis passing through the optical axis of the right headlight, said strips being at least tangential to said axis along one edge. Apart from the arrangements outlined above, the invention consists of a certain number of other arrangements, as discussed in more detail below in respect of illustrative embodiments described with reference to the accompanying drawings, but which are in no way restrictive. In the drawings:

FIG. 1 is a drawing of a light beam composed of three superposed horizontal strips produced by at least one module according to the invention.

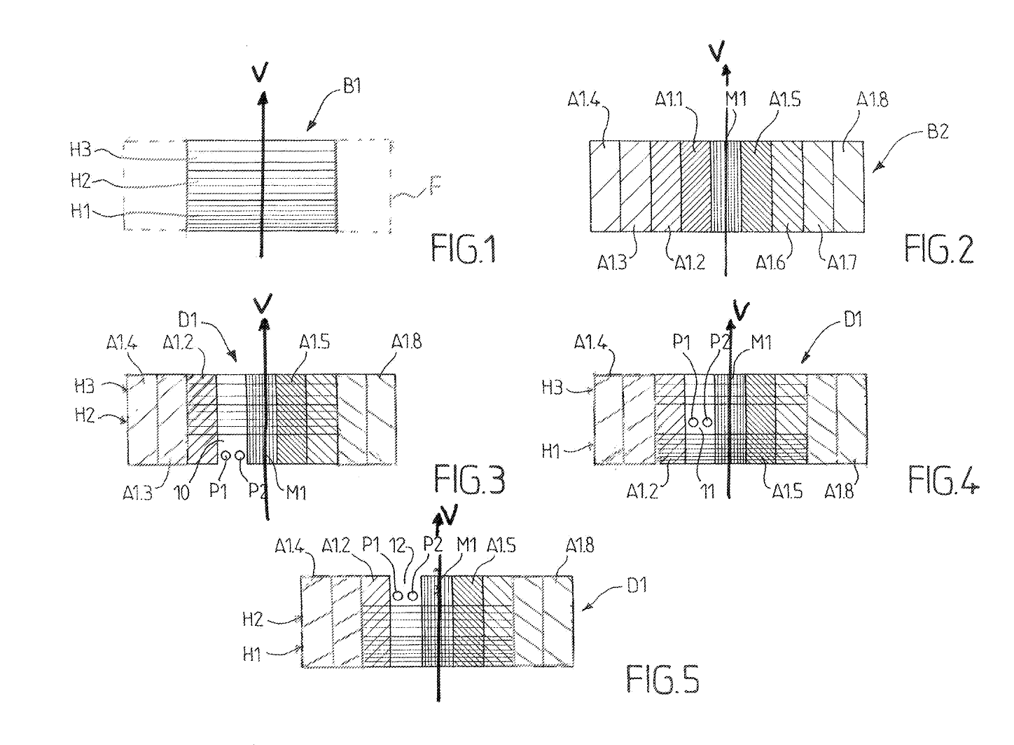

FIG. 2 is a drawing of a light beam formed from nine contiguous juxtaposed vertical strips, obtained by the use of corresponding modules.

FIG. 3 represents the beam of a headlight composed of modules producing the beams in FIG. 1 and FIG. 2, when a vehicle approaching in the opposite direction is detected in the low part of the beam.

FIG. 4 depicts, similarly to FIG. 3, the combined beam of the headlight in the case of a vehicle approaching in the opposite direction, at mid-height.

FIG. 5 depicts, similarly to FIG. 3, the beam of the headlight in the case in which a vehicle approaches in the opposite direction in the high position.

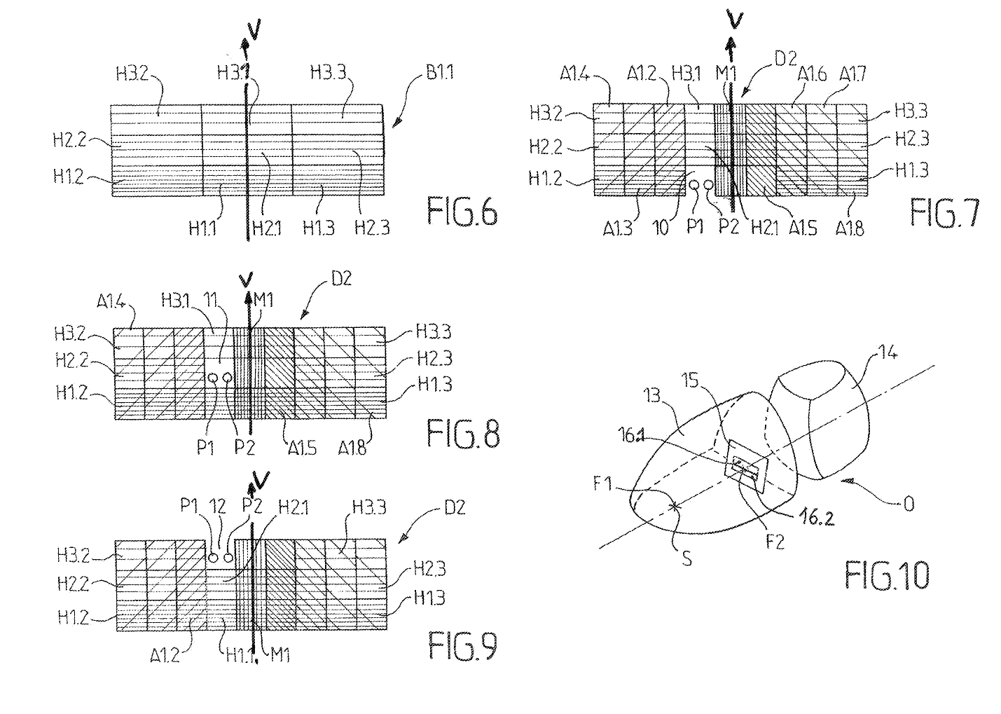

FIG. 6 illustrates the beam obtained with modules having horizontal strips extending for one third of the width of the total beam.

FIG. 7 illustrates the combined beam of a headlight including modules producing the drawings in FIG. 6 and in FIG. 2, in the case in which a vehicle is approaching in the lowest part.

FIG. 8 depicts, similarly to FIG. 7, the beam of the headlight in the case of a vehicle approaching at mid-height.

FIG. 9 represents the beam of the headlight in FIG. 7 in the case of a vehicle approaching in the high part.

FIG. 10 is a summary drawing in perspective of optical means with a shield making it possible to obtain a pixel constituted by two juxtaposed, vertically offset horizontal light strips.

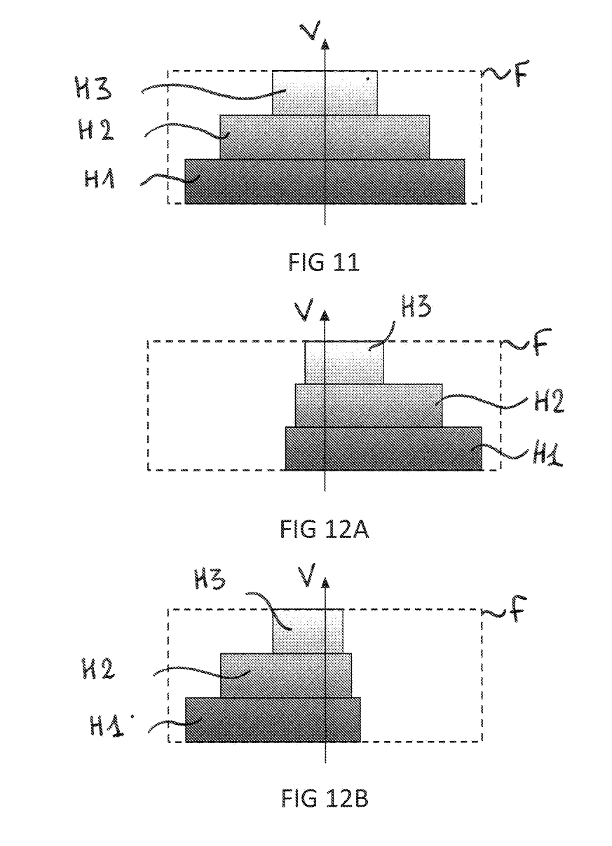

FIG. 11 is a drawing of a variant of a light beam composed of three superposed horizontal strips produced by at least one module according to the invention.

FIGS. 12 A and B are a drawing of another variant of a beam of horizontal strips, respectively of a right headlight and of a left headlight combined in a lighting assembly according to the invention.

With reference to FIG. 1 in the drawings, a light beam B1 provided by at least one light module, of which an illustrative embodiment is described with regard to FIG. 10, can be seen schematically represented in the form of a rectangle. The one, or each, light module includes at least one light source S (FIG. 10) and optical means O in order to form an illuminated zone including at least two horizontal light strips. According to the example in FIG. 1, three horizontal light strips H1, H2, H3 are offset vertically, juxtaposed with their contiguous horizontal edges. As a variant, the light strips could be inclined in relation to the horizontal while extending in the transverse direction of the beam.

According to the example in FIG. 1, the horizontal light strips extend for a fraction of the width of the beam F of the headlight, as represented by a broken line. According to the variant illustrated here, the horizontal strips are distributed symmetrically in relation to the vertical axis V passing through the optical axis of the headlight. Furthermore, they each have the same horizontal extent. According to another variant, illustrated in FIGS. 11 and 12, the horizontal strips have a decreasing extent in the vertical sense, from bottom to top, the lower strips being wider than the upper strips. This makes it possible advantageously to obtain a light distribution close to that of a “conventional” high beam, which is obtained with an elliptically shaped device having a lens or a reflector.

According to one variant embodiment of the variant having a decreasing extent of the strips in the vertical sense, the strips may be segmented into juxtaposed patterns, of which the number decreases with the height. With reference to FIG. 11, the strip H1 may thus be composed of five pixels, the intermediate strip H2 being composed of three pixels and the upper strip H3 being composed of a single pixel.

The light distribution near the horizon is optimized in this way, this being a zone where the probability of having another vehicle is highest. There is a reduced variation in flux during the modification of the lower line, since each pattern is separately controllable.

The optical means O are preferably arranged in order to generate horizontal light strips, of which the contour exhibits at least two edges opposite and parallel to one another. In particular, the contour is rectangular or square.

FIG. 2 represents schematically, in the form of a rectangle having a more extended surface than that in FIG. 1, a light beam B2 obtained with light modules producing at least one vertical light strip: M1 for the central strip and A1.1-A1.4 for the vertical strips situated to the left of the central strip and A1.5-A1.8 for the light strips situated to the right of the central strip. A headlight regroups the modules producing the horizontal strips in FIG. 1 and the vertical strips in FIG. 2, which intersect as illustrated in FIG. 3, representing the resulting overall beam D1. The headlight includes an assembly of modules resulting from the combination of the one or more modules in order to produce the drawing in FIG. 1 and modules in order to produce the drawing in FIG. 2. The light beam B2 covers the whole of the width of the beam F of the headlight.

According to a preferred characterizing feature, the extent of the pixels or horizontal strips is greater than the greatest width of the vertical light strips of the headlight, when there are at least two, and preferably at least three thereof: each horizontal strip thus has an extent overlapping more than one vertical strip in width.

Each module of the headlight is controlled individually by means, not illustrated here, that are sensitive to the presence of one or a plurality of vehicles which may approach in the opposite direction of the vehicle in question, or of one or a plurality of vehicles driving in the same direction, but in front of the vehicle in question. These sensitive means are dedicated to extinguishing the one or more modules of which the light patterns may cause glare for the drivers approaching in the opposite direction or driving in front of the vehicle in question. These means are generally sensitive to the light emitted by the headlights P1, P2 (FIG. 3-5) of a vehicle approaching in the opposite direction, or by the signaling lights of a vehicle driving in front. Other means that are sensitive to the presence of vehicles in the opposite direction or in front could be used, such as radars, although these are generally more expensive.

According to the example in FIG. 3, a vehicle approaching in the opposite direction is detected in the low position to the left of the vertical central pattern M1. The sensitive means control the extinguishing of the module producing the pattern A1.1, as well as the extinguishing of the pattern H1, corresponding to the lower horizontal strip in FIG. 1. A non-illuminated rectangular zone 10 is accordingly formed around the vehicle approaching in the opposite direction, which avoids causing glare for the driver of this vehicle. However, for the driver of the vehicle equipped with the headlight producing the beam D1, light is retained above and to either side of the vehicle approaching in the opposite direction, which is favorable for good vision and improves the driving conditions.

FIG. 4 illustrates, similarly to FIG. 3, the light beam of the headlight when the headlamps P1, P2 of a vehicle approaching in the opposite direction are detected substantially at mid-height, to the left of the central vertical strip M1. The pattern corresponding to the vertical strip A1.1 is extinguished, as in the case of FIG. 3, whereas the mean horizontal light strip H2 is extinguished when the lower strip H1 and the upper strip H3 (FIG. 1) remain lit. The vehicle approaching in the opposite direction is situated in a rectangular zone 11 which is not illuminated, although illumination which assists with driving the vehicle in question is still present around the whole of this zone.

FIG. 5 is a drawing illustrating the case in which the vehicle approaching in the opposite direction is detected by its headlamps P1, P2 in a zone corresponding to the high part of the beam, to the left of the central vertical strip M1. The vertical strip A1.1 is extinguished as well as the upper horizontal strip H3, such that the zone 12 situated at the intersection of these two vertical and horizontal strips is not illuminated around the vehicle approaching in the opposite direction. Illumination is retained to either side of the zone 12 and beneath said zone, which assists with driving for the driver of the vehicle in question.

In summary, only the horizontal pixel and the vertical pixel impacting the vehicle approaching in the opposite direction are extinguished.

FIG. 6 illustrates a variant according to which each horizontal light strip of the beam F of the headlight is obtained with the help of modules providing horizontal light patterns extending for a fraction of the total width of the beam F of the headlight. It is possible, for example, to choose an extent over one third of the width. Each strip is thus formed by three patterns designated respectively by H1.1, H2.1, H3.1 for the central patterns, and by H1.2, H2.2, H3.2 for the patterns situated to the left of the central pattern, whereas the patterns situated on the right are designated by H1.3, H2.3 and H.3.3. The beam B1.1 in FIG. 6 is thus obtained with the help of modules of which the horizontal strips, which are offset vertically, are juxtaposed, having contiguous edges, both in the vertical direction and in the horizontal direction. It is possible according to the same principle to segment each light strip of the beam as illustrated in FIG. 1.

The part of the beam constituted by juxtaposed vertical light strips remains the same and, in the example in question, is constituted by nine vertical strips as illustrated in FIG. 2. The overall beam D2 is composed, when all of the strips are lit, of nine horizontal patterns and nine vertical strips.

In the case of a vehicle approaching in the opposite direction, in the low position, on the left side of the central vertical strip M1, as illustrated in FIG. 7, the vertical strip A1.1 is extinguished, as is the pattern H1.1 of the lower horizontal strip. The non-illuminated zone 10 can be seen, in which the vehicle approaching in the opposite direction is present. However, the zone impacted by the extinguishing of the pattern, or pixel, H1.1 is reduced in relation to the case depicted in FIG. 3, since the patterns H1.2 and H1.3 are kept illuminated to either side of the zone 10, which improves the illumination for the driver of the vehicle in question.

FIG. 8 illustrates schematically the beam D2 obtained when a vehicle approaching in the opposite direction is situated substantially at mid-height. The non-illuminated zone 11 in FIG. 4 obtained by extinguishing the vertical strip A1.1 and the pattern H2.1 can be seen. On the other hand, the patterns H2.2 and H2.3 remain illuminated to either side of zone 11, which improves the illumination for the driver in question, that is to say the driver of the vehicle equipped with the modules in question.

Similarly, if the vehicle approaching in the opposite direction is situated in the high part of the beam, as illustrated in FIG. 9, the non-illuminated 12 zone in which the approaching vehicle is present, obtained by extinguishing the vertical strip A1.1 and the pattern H3.1, can be seen. On the other hand, the patterns H3.2 and H3.3 remain illuminated, which assists with driving.

In the illustrative embodiment in FIGS. 6-9, the headlight includes modules to produce the horizontal partial strips and modules to produce the vertical strips.

The invention also has as its object a lighting assembly for a motor vehicle including a left headlight and a right headlight mounted respectively on the left side and the right side at the front of the vehicle, said right and left headlights being produced as described above.

According to a first variant embodiment, the left headlight and the right headlight of the vehicle are similar, and their beams are brought together by the superposition of their respective optical axes in order to provide the global beam of the vehicle. The design of the modules and the method of realization of a lighting assembly for a vehicle having two headlights, one left and one right, are simplified in this way.

According to another variant, the distribution of the horizontal strips is different depending on whether the left headlight or the right headlight is being considered.

In a preferred manner and with reference to FIGS. 12A and 12B, the assembly made up of the transverse strips H1, H2, H3 of the left headlight (FIG. 12B) is offset to the left side in relation to the vertical axis V passing through the optical axis of the left headlight, and the assembly made up of the transverse strips of the right headlight (FIG. 12A) is offset to the right side in relation to the vertical axis V passing through the optical axis of the right headlight, said strips being at least tangential to said axis V along one edge.

This configuration is particularly interesting in that it optimizes the utilization of the light emitted by the modules and, in so doing, facilitates the achievement of a satisfactory light distribution towards the part of the vehicle described as the interior part, that is to say contained within the width of the vehicle and to the front thereof, containing the longitudinal median plane of the vehicle. The integration of the modules is facilitated, furthermore, since their offset asymmetrical distribution in relation to the vertical axis V makes it possible to position them as close as possible to the longitudinal median plane of the vehicle.

FIG. 10 illustrates schematically a mode of implementation of optical means O in order to produce the previously described pixels or light patterns.

These optical means O include an elliptical reflector 13 that is open towards the front, and a lens 14 for focusing the light beam. The light source S is situated in a first foyer F1 of the reflector 13. Disposed in the plane orthogonal to the optical axis and passing through the second foyer F2 of the reflector is a shield 15, provided in which are at least two horizontal rectangular windows 16.1, 16.2, offset vertically, of which the shape corresponds to that of the desired horizontal pattern for FIG. 1 or FIG. 6. If there was a desire to produce at least one vertical strip, one rectangular window would be oriented with its large dimension vertical. The foyer of the lens 14 is combined with the second foyer F2 of the elliptical reflector, of which the optical axis is common with that of the lens 14. This lens provides any number of images of the windows 16.1, 16.2 making up the desired pattern or pixel. If necessary, more than two vertically offset parallel horizontal windows may be provided in the shield 15. Means (not represented here) may be provided in order to occult automatically one or a plurality of windows according to need.

The solution proposed by the invention, with a horizontal raster according to FIG. 1, FIG. 6, FIG. 11 or FIG. 12 and a vertical raster of pixels according to FIG. 2, makes it possible to reduce the zone impacted by the extinguishing of the pixels and to maintain good illumination outside this zone. In addition, the solution thus proposed calls for only a small number of light sources in relation to solutions for matrices of light sources, in particular LEDs, of which the switching control is extremely complicated.

1. A motor vehicle headlight including a plurality of light modules, said motor vehicle headlight comprising a first group of modules to form at least two juxtaposed transverse light strips (H1, H2, H3; H1.1 . . . H3.3), and at least a second group of modules arranged to form contiguous juxtaposed vertical light strips (M1, A1.1 . . . A1.8).

2. The motor vehicle headlight as claimed in claim 1, wherein said transverse light strips (H1, H2, H3; H1.1 . . . H3.3) are horizontal.

3. The motor vehicle headlight as claimed in claim 1, wherein said transverse light strips (H1.1 . . . H3.3) extend only for a fraction of the width of a beam (F) of said motor vehicle headlight.

4. The motor vehicle headlight as claimed in claim 1, wherein said first group of modules includes a plurality of modules in order to produce at least two segmented transverse strips, each module forming a pattern in the form of said transverse light strip (H1.1 . . . H3.3) corresponding to a fraction of the total width of a beam (F) of said motor vehicle headlight.

5. The motor vehicle headlight as claimed in claim 1, wherein said first group of modules includes a plurality of modules in order to produce at least two transverse segmented strips extending over the full width of a beam (F), each module forming a pattern (H1.1 . . . H3.3) corresponding to a fraction of the total width of said transverse light strip.

6. The motor vehicle headlight as claimed in claim 5, wherein said first group of modules includes modules in order to form three transverse light strips, in particular horizontal, offset vertically and juxtaposed with contiguous edges extending for the full width of said beam (F), each strip being composed of three fractions (H1.1 . . . H3.3), each extending for one third of the width of said beam (F) of said motor vehicle headlight.

7. The motor vehicle headlight as claimed in claim 1, wherein the extent of said transverse light strips decreases in the vertical sense, from bottom to top, the lower strip being more extensive than the successive upper strip.

8. The motor vehicle headlight as claimed in claim 1, wherein said transverse light strips are distributed symmetrically in relation to a vertical axis (V) passing through an optical axis of said motor vehicle headlight.

9. The motor vehicle headlight as claimed in claim 1, wherein an assembly made up of said transverse light strips is offset to one side or the other in relation to a vertical axis (V) passing through an optical axis of said motor vehicle headlight, said vertical light strips being at least tangential to said vertical axis (V) along one edge.

10. A lighting assembly for a motor vehicle including a left headlight and a right headlight, mounted respectively on the left side and the right side at the front of the vehicle, wherein said right and left headlights are produced as claimed in claim 1.

11. The lighting assembly for a motor vehicle as claimed in claim 10, wherein the distribution of said transverse light strips of said first group of modules is different between said left headlight and said right headlight.

12. The lighting assembly for a motor vehicle as claimed in claim 11, wherein said lighting assembly made up of said transverse light strips of said left headlight is offset to the left side in relation to a vertical axis (V) passing through an optical axis of said left headlight and in that said lighting assembly made up of said transverse light strips of said right headlight is offset to the right side in relation to a vertical axis (V) passing through an optical axis of the said right headlight, said transverse light strips being at least tangential to said vertical axis (V) along one edge.

13. The motor vehicle headlight as claimed in claim 2, wherein said transverse light strips (H1.1 . . . H3.3) extend only for a fraction of the width of a beam (F) of said motor vehicle headlight.

14. The motor vehicle headlight as claimed in claim 2, wherein said first group of modules includes a plurality of modules in order to produce at least two segmented transverse strips, each module forming a pattern in the form of said transverse light strip (H1.1 . . . H3.3) corresponding to a fraction of the total width of a beam (F) of said motor vehicle headlight.

15. The motor vehicle headlight as claimed in claim 2, wherein the extent of said transverse light strips decreases in the vertical sense, from bottom to top, the lower strip being more extensive than the successive upper strip.

16. The motor vehicle headlight as claimed in claim 3, wherein the extent of said transverse light strips decreases in the vertical sense, from bottom to top, the lower strip being more extensive than the successive upper strip.

17. The motor vehicle headlight as claimed in claim 2, wherein said transverse light strips are distributed symmetrically in relation to a vertical axis (V) passing through an optical axis of said motor vehicle headlight.

18. The motor vehicle headlight as claimed in claim 3, wherein said transverse light strips are distributed symmetrically in relation to a vertical axis (V) passing through an optical axis of said motor vehicle headlight.

19. The motor vehicle headlight as claimed in claim 2, wherein an assembly made up of said transverse light strips is offset to one side or the other in relation to a vertical axis (V) passing through an optical axis of said motor vehicle headlight, said vertical light strips being at least tangential to said vertical axis (V) along one edge.

20. The motor vehicle headlight as claimed in claim 7, wherein an assembly made up of said transverse light strips is offset to one side or the other in relation to a vertical axis (V) passing through an optical axis of said motor vehicle headlight, said vertical light strips being at least tangential to said vertical axis (V) along one edge.
